(19) United States
(12) Patent Application Publication
(10) Pub. No.: US 2003/0152450 A1
(43) Pub. Date: Aug. 14, 2003

(54) Portable mortar dispensing and mixing device

(76) Inventors: Steve Henry, Mt. Auburn, IA (US); Rex Kinsey, Lincoln, NE (US)

Correspondence Address: MCKEE, VOORHEES & SEASE, P.L.C., 801 GRAND AVENUE, SUITE 3200, DES MOINES, IA, 50309-2721, US

(21) Appl. No.: 10/075,906

(22) Filed: Feb. 14, 2002

(51) Int. Cl. B60P 1/00

(52) U.S. Cl. 414/502

(57) ABSTRACT

A self-contained properly balanced for loaded towing mobile masonry unit. The unit has a towable trailer and mounted on the trailer in position to properly balance the load for loaded towing are a product hopper, a water tank, and an operatively associated cement mixer.

### FIELD OF THE INVENTION

This invention relates to a portable self-contained mixing apparatus that is towable, even when loaded.

### BACKGROUND OF THE INVENTION

Even with the recent development of pre-mixed mortar, i.e. products that include the necessary sand and cement, the mixing of mortar for brick work is still highly labor and equipment intensive. Typically, a water tanker, many different trucks and material handling devices are required. As a result, if the work is done on an existing residential structure, yards are often destroyed by all the heavy equipment brought to the site and by the cement, mortar, sand, etc. that inevitably end up in the yard.

Since the introduction of super sacks containing cementuous materials unloaded into silos that are set up on masonry job sites, which sacks dispense material directly into the silo and from there into a mixer placed under the silo, brick masons have still wanted a piece of equipment that is a self-contained mobile unit focused towards smaller jobs (residential market instead of the commercial market). The desire for this is to avoid the typical water tanker and many different trucks and material handling devices that are required at the construction site.

There have been previous attempts at portable units such as Shuff, U.S. Pat. No. 5,624,183. However, devices of which the Shuff patents are representative, are cumbersome, do not tow easily, and are not truly a self-contained unit that can be loaded and then towed to the site. Such units such as Shuff, which are essentially nothing more than a cement truck on a trailer, therefore do not satisfy the current need. In short, the need for on-site mixing and handling destroys any of the significant advantages of portability.

It can been seen, therefore, that there is a continuing need for the development of a self-contained unit, which can be fully loaded, mortar, sand and water, and then driven to a site and used with material dispensed from the unit as needed on site. Since everything is self-contained, nothing would be spilled and site destruction would not occur.

One of the problems in theory with such units that must be overcome is that as the cement, sand and water are loaded, the trailer becomes heavy and difficult to tow. The unit of the present invention provides the advantages of an all self-contained unit and the portability while still being towable, even when loaded.

### SUMMARY OF THE INVENTION

A self-contained properly balanced for loaded towing, mobile masonry unit. The unit has a towable trailer and mounted on the trailer in position to properly balance the load are a product hopper, a water tank, and an operatively associated cement mixer.

### BRIEF DESCRIPTION OF THE DRAWINGS

FIG. 1 is a perspective view of the mobile masonry unit of the present invention.

FIG. 2 is a plan view of the unit of FIG. 1.

FIG. 3 is a side view of the unit of the invention shown as it loads dry cement.

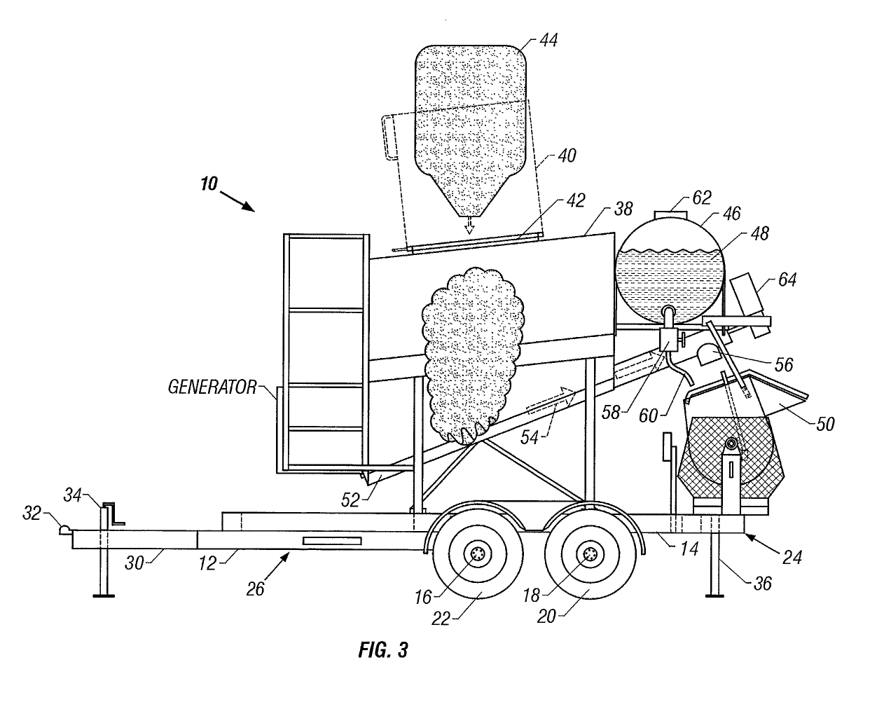

FIG. 4 is a side view of the unit showing the auger in operation and the metering of water as sand and dry cement are dumped into the cement mixing unit.

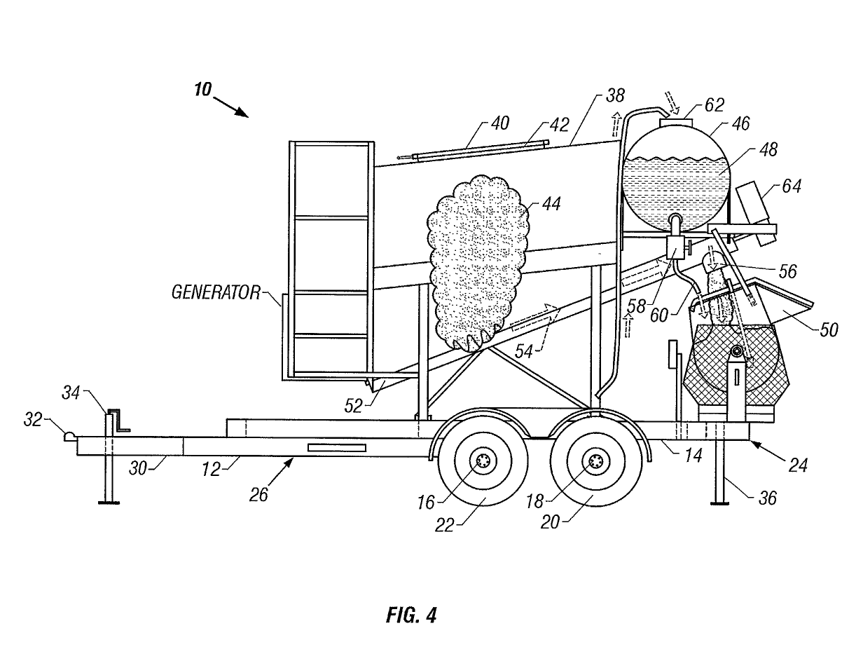

FIG. 5 shows mixed cement dumping into a wheel barrel for use by a mason on site, and illustrates the all-contained nature of the unit.

### DETAILED DESCRIPTION OF THE PREFERRED EMBODIMENT

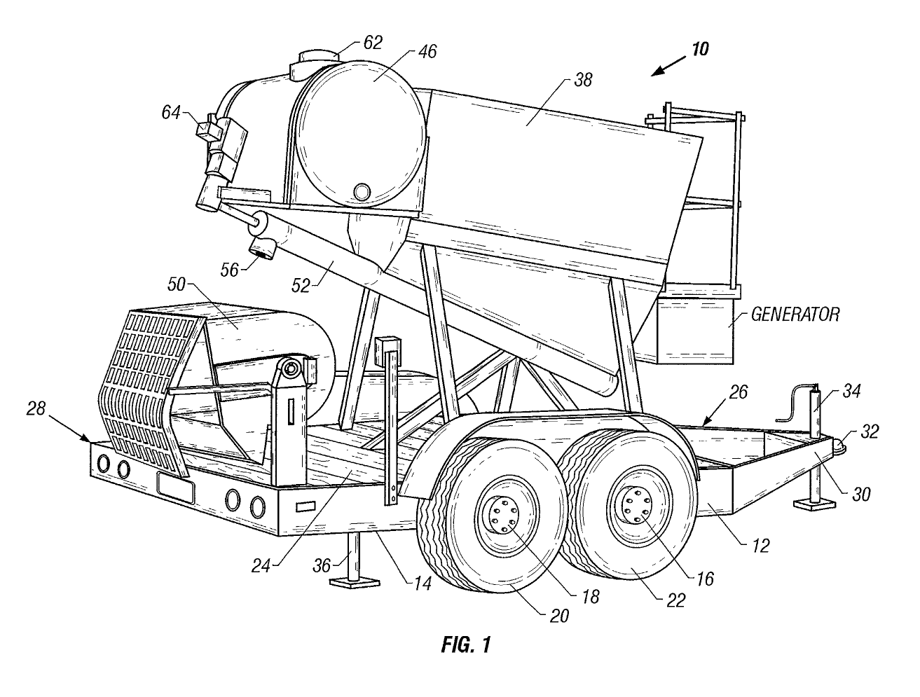

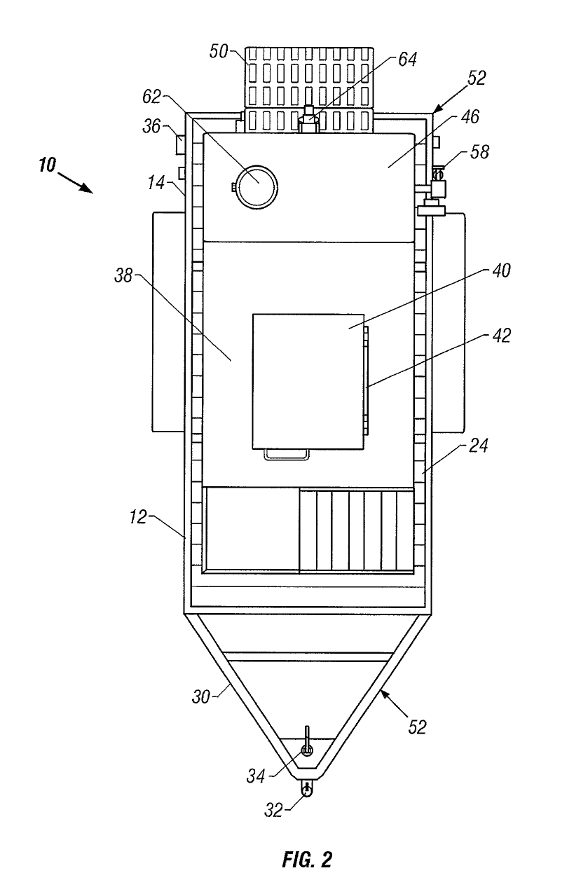

FIG. 1 is a perspective view of the masonry mobile unit 10 of the present invention. FIG. 2 shows the unit in plan view so its load bearing locations with respect to the trailer can be easily identified and determined.

The masonry mobile unit 10 is all mounted on trailer 12 which forms a part of the entire unit 10. Trailer 12 is a trailer of conventional construction and as illustrated has an under carriage or frame 14, dual axles 16 and 18, and dual wheels 20 and 22. Mounted to trailer 12 is a support platform 24. For descriptive purposes, the trailer 12 is defined as having a forward towing end 26 and a rear end 28. Forward of towing end 26 is towing tongue 30, hitch 32 and retractable and height adjustable stand 34 of conventional construction. Similarly mounted adjacent rear 28 of trailer 12 is a rear adjustable and retractable stand 36.

The rest of the unit is mounted on platform 24, and importantly positioned so that the load and weight of the unit are focused on top of the dual carriage wheels 20 and 22, with little or none of the weight forward or up front of carriage wheel 16. In particular, it is estimated that less than 10% of the weight of the loaded unit is forward of the front carriage wheel 16 and the weight on tow hitch 32 is only on a small fraction, estimated at 7% of the weight of the fully loaded unit 10. This allows the unit, even when fully loaded, to tow satisfactorily.

Mounted on the unit and substantially over the dual carriage wheels 16 and 18 is a product container or hopper 38. Hopper 38 has a hinged door 40. Via hinge 42 the door is opened and super sacks of pre-blended sand and cement, as illustrated at 44, are dumped into hopper 38. Once hopper 38 is filled, door 40 can be closed and the super sack 44 removed. Mounted to the platform 24 and the framework of hopper 38 generally rearward of dual carriage wheel 18 is water tank 46. Water tank 46, filled with water 48, is positioned high on the framework, above associated cement mixer 50. Communication from hopper 38 to cement mixer 50 to allow transport of preblended dry mortar accomplished via auger 52. Auger 52 communicates with the bottom of hopper 38 such that cement material falls into auger 52 and when it is powered, either by gas powered electrical generator or by suitable on site electrical hook up, the material is communicated upwardly via directional arrow 54 to its exit 56 where the material can be metered into cement mixer 50. Correspondingly, water 48 in tank 46 can be metered through valve 58 and drain line 60 into cement mixer 50. Of course water is placed in tank 46 via a top fitting using a conventional garden hose. A typical tank 46 is made of a polymeric inner plastic material such as polyethylene and a suitable size found satisfactory for the invention has been 120 gallon plastic tank. Motor 64 drives auger 52 and can be operated either by a gas operated generator, or by an electrical source. Motor 64 suitably can be a 32:1 ratio motor. Thus, it can be seen that the system includes a trailer, a product container to hold preblended cementuous material, a mixer, a water tank, a generator, electrical unit hookup, a water tank with associated valve, a stabilizer stand, and a work platform. All are positioned so that little of the load bearing weight is forward of the dual carriage wheel 16 and 18, and most if not all of it is either directly over the carriage wheels or in back of them. During transport the load bearing material will be in hopper 38 and the water in tank 46.

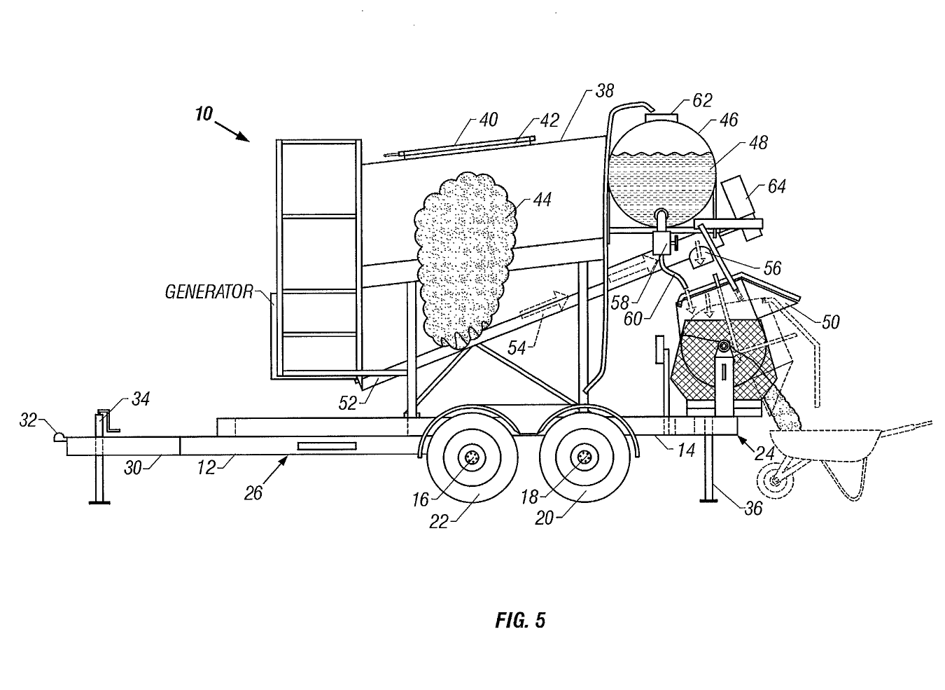

The unit works in the following manner. Super sacks 44 of pre-blended material are lifted by a forklift type piece of equipment into a large hinged door 40 opening on top of the product container 38. A person standing on the work platform 64 attached to the front of the product container 36 empties super sacks 44 into the product container 38. Once lid 40 is closed the product 44 remains dry and free from the elements. The water tank 46 is filled from the ground with a garden hose that is hooked to plumbing which fills the tank 46 from the top 62. This water 48 is then fed into mixer 50 by gravity regulated by a valve 58. The unit 10 is now ready to be pulled to the job site. Once at the job site, the unit 10 may be unhooked from the pulling vehicle by means of a tongue jack 34. Once unhooked, the stabilizer stand 36 located at the rear 28 of the trailer 12 must be extended to stabilize the weight when mixer 50 is being loaded with product. The operator would start generator 66 which is mounted on the lower part of work platform 64. The operator then would turn on one of two switches (not depicted) that activate the mixer 50. Water via gravity line 60 falls or drains into the mixer 50 at which time one would then activate the second switch (not depicted) which turns the auger motor 64 on which delivers the pre-blended material from the product container 38 into the mixing chamber of the mixer 50. When desired amounts and consistency are achieved, the auger switch and water valve are shut off. The mixer 50 continues to operate until thorough mixing is achieved. At that time mixer 50 is tilted (FIG. 5) and cement poured into a wheel barrow 68 or other device for the mortar to be delivered to the mason. At that time another batch can be mixed or if job is completed, water placed in the mixer for clean up. Nothing is left or spilled over at the site.

The generator 66 also allows for a variety of power tools to be used off of it, such as lights, water pump for pressure water, and even a high pressure washer for wall cleaning, if desired.

Optionally, a storage container could also be mounted near the front of the trailer to store light hand tools, shovels, etc.

This unit 10 allows masonry work to be performed in very remote locations, and could very easily eliminate one person from the equation or at least free up one person to do other things.

From the above description of the sequence of operations and events, it can be seen that the unit accomplishes all of its stated objectives.

What is claimed is:

1. A self-contained properly balanced for loaded towing mobile masonry unit, comprising:
a towable trailer having a forward towing end, a read end, and at least one axle, and a pair of spaced apart wheels mounted to the axle; and
mounted to the trailer, and positioned on said trailer to balance the trailer for loaded towing, a product hopper, an operatively associated water tank, and an operatively associated cement mixer.

2. The mobile masonry unit of claim 1 which includes an auger mounted to the product hopper to meter dry product from the product hopper to the cement mixer.

3. The mobile masonry unit of claim 2 which includes a power unit to operate the auger and the cement mixer.

4. The mobile masonry unit of claim 3 wherein the water tank is mounted above the cement mixer to allow water to be gravity fed into the cement mixer.

5. The mobile masonry unit of claim 3 wherein the power is selected from the group consisting of a gas operated generator and an electric hook up.

6. The mobile masonry unit of claim 1 which has a retractable stabilizer stand mounted adjacent the trailer rear end.

7. The mobile masonry unit of claim 1 wherein the trailer has a pair of dual axles and wheels.

8. The mobile masonry unit of claim 1 wherein the unit includes an optional lightweight tool storage container.
